(19) United States
(12) Patent Application Publication
(10) Pub. No.: US 2025/0296132 A1
(43) Pub. Date: Sep. 25, 2025

(54) IRONING ROLL THERMAL IMAGE MONITORING AND CONTROL

(71) Applicant: Novelis Inc., Atlanta, GA (US)

(72) Inventors: Luiz Augusto Leal Leal, Spanish Fort, AL (US); Tiago Sanini Moraes, Taubate (BR); Carlos Alberto Jorio Eboli, Acworth, GA (US); Ademir Alves, Pindamonhangaba (BR); Simon Lachnitt, Boppard (DE)

(73) Assignee: Novelis Inc., Atlanta, GA (US)

(21) Appl. No.: 18/862,270

(22) PCT Filed: Apr. 21, 2023
(86) PCT No.: PCT/US2023/019426

§ 371 Date: Nov. 1, 2024

Related U.S. Application Data
(60) Provisional application No. 63/364,057, filed on May 3, 2022.

(51) Int. Cl. B21B 38/00; B21B 15/00; G01J 5/00

(52) U.S. Cl. CPC B21B 38/006; G01J 5/0022; G01J 5/0066; B21B 2015/0057

(57) ABSTRACT

A metal processing system includes a roll and a control system. The roll includes a non-metal surface for contacting a metal substrate, and the control system includes a sensor for detecting a temperature of the non-metal surface of the roll. The control system also includes a controller, which receives the detected temperature from the sensor and controls the roll based on the detected temperature. A method of controlling the roll with the non-metal contact surface includes receiving a detected temperature of at least a portion of the non-metal contact surface of the roll from a sensor, and controlling the roll based on the received temperature.

### REFERENCE TO RELATED APPLICATION

This application claims the benefit of U.S. Provisional Patent Application No. 63/364,057, filed on May 3, 2022, and entitled IRONING ROLL THERMAL IMAGE MONITORING AND CONTROL, the content of which is hereby incorporated by reference in its entirety.

### FIELD OF THE INVENTION

This application relates to metalworking generally, and more specifically to systems and methods for controlling an ironing roll of a metal processing system.

### BACKGROUND

A metal product may be rolled into a strip of metal during a rolling operation, and the strip of metal may be wound into a coil. During coiling of the metal strip, an ironing roll may be used to force the metal strip against the coil to help ensure that the coil is tightly wound and to minimize or prevent damage at the surface of the metal strip. Any instance of using an incorrect force (e.g., due to misalignment of the ironing roll, an unbalanced ironing roll, etc.) can result in a scratch or scar to a surface of the metal strip. Moreover, failure of the ironing roll itself is another major cause of scratching and gouging of the surface of the metal strip. In particular, a rubber coating of the ironing roll commonly bursts and otherwise fails during metal processing, sometimes unexpectedly, and such failure often forms a scratch or gouge in the surface of the metal strip. Such damage to the metal strip requires scrapping of the damaged portion of the coil or even the entire coil.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a metal processing system includes a roll and a control system. The roll is rotatable about an axis and includes a first end, a second end, and a non-metal surface between the first end and the second end for contacting a metal substrate. The control system includes a sensor for detecting a temperature of the non-metal surface of the roll. The control system also includes a controller communicatively coupled with the sensor. The controller may receive the detected temperature from the sensor and control the roll based on the detected temperature.

According to some embodiments, a control system for a metal processing system having a roll with a non-metal contact surface includes a sensor for detecting a temperature of the non-metal contact surface of the roll, and a controller communicatively coupled with the sensor. The controller may receive the detected temperature from the sensor and generate an output signal for controlling the roll based on the received temperature.

According to various embodiments, a method of controlling a roll with a non-metal contact surface for contacting a metal substrate includes receiving a detected temperature of at least a portion of the non-metal contact surface of the roll from a sensor, and controlling the roll based on the received temperature.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a metal processing system with an ironing roll and a control system according to embodiments, and with the ironing roll in a first position relative to a sensor of the control system.

FIG. 2 illustrates an ironing roll of FIG. 1.

FIG. 3 illustrates the metal processing system of FIG. 1 with the ironing roll in a second position relative to the sensor.

FIG. 4 illustrates the ironing roll from the control system of FIG. 1 with detection zones according to embodiments.

FIG. 5 is a top view of the sensor of the control system and the ironing roll of FIG. 1 with the ironing roll in the first position and the second position.

FIG. 6 illustrates the ironing roll of FIG. 1 in the first position and the second position relative to the sensor of the control system.

FIG. 7 illustrates a metal processing system with an ironing roll and a control system according to embodiments.

FIG. 8 illustrates a temperature profile of another ironing roll according to embodiments.

FIG. 9 illustrates a temperature profile of an ironing roll before and after control of the ironing roll with a control system according to embodiments.

### DETAILED DESCRIPTION

Described herein are systems and methods for controlling a roll of a metal processing system and with a non-metal surface. The roll may be for contacting a surface of a metal substrate, including but not limited to an ironing roll for contacting a surface of a metal substrate in a coil. In certain embodiments, the systems and methods provided herein include a control system that measures and detects a temperature of the non-metal surface of the roll and controls an operating parameter of the roll based on the detected temperature. In certain embodiments, the control system measures the temperature in a plurality of zones across a width of the roll, which may allow for the detection of differences in the temperature of the roll, which may differ from one side to the other, and allow for correction as needed.

In some embodiments, the control system may amplify and/or otherwise control a size of the zones based on a distance between a sensor of the control system and the roll, which may improve measurement and/or control based on such temperature measurements by maintaining a proportion of the roll measured for a particular zone (i.e., the size of the measured area relative to the overall roll remains proportional regardless of the distance between the sensor and the roll). In certain embodiments, the systems and methods provided herein may prevent and/or minimize failure of an ironing roll during metal processing, thereby minimizing and/or preventing defects or damage in a metal substrate (e.g., scratch gouges) due to failure of the ironing roll. In some embodiments, the systems and methods provided herein may be used to predict failure or a usable life of an ironing roll such that the ironing roll can be replaced as needed before failure of the ironing roll. In various embodiments, the systems and methods provided herein may provide improved flatness control with using an ironing roll. Various other benefits and advantages may be realized with the systems and methods provided herein, and the aforementioned advantages should not be considered limiting.

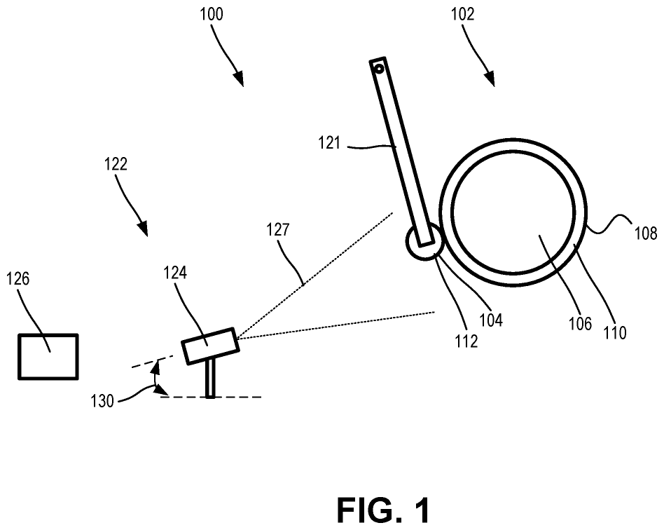

FIGS. 1-6 illustrate a metal processing system 100 with a work station 102 that includes at least one roll 104. In the embodiment of FIGS. 1-6, the work station 102 is a coiling station that includes a coiler 106 for selectively forming a coil 108 of a metal substrate 110 or uncoiling the coil 108. The roll 104 in this embodiment is an ironing roll for contacting the coil 108 to promote good coiling and buildup of the coil 108 and/or uncoiling of the metal substrate 110 from the coil 108. While the work station 102 is illustrated as a coiling station and the roll 104 as an ironing roll, in other embodiments the work station 102 need not be a coiling station and/or the roll 104 need not be an ironing roll, and the roll 104 may be provided at various other locations within a metal processing system as desired. As some non-limiting examples, the work station 102 with the roll 104 may be a cold mill, a foil mill, a slitter line, a continuous annealing solution heat treating line, a coating line, and/or various other types of stations and/or metal processing systems as desired.

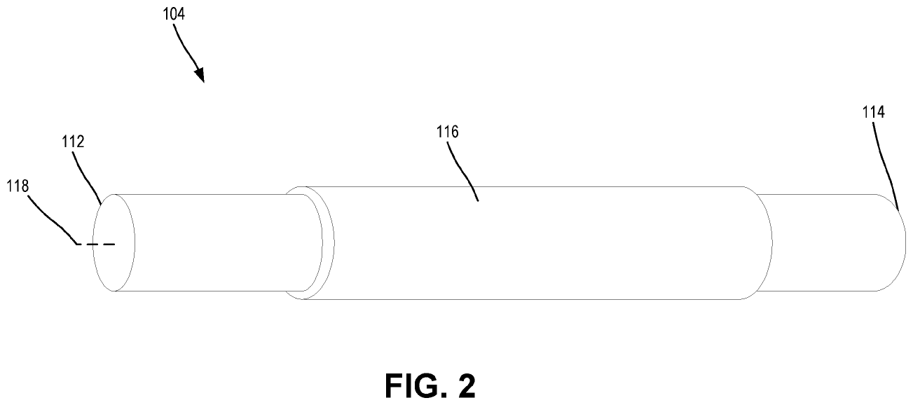

Referring to FIG. 2, in various embodiments, the roll 104 includes a first end 112, a second end 114, and a contact surface 116 between the first end 112 and the second end 114. In certain embodiments, the contact surface 116 is a non-metal surface suitable for contacting the metal substrate 110 during processing of the metal substrate 110 (e.g., coiling or uncoiling in FIGS. 1-6) as the roll 104 rotates about its axis 118. In one non-limiting example, the contact surface 116 is a rubber coating provided on the roll 104 between the ends 112, 114. Optionally, the non-metal surface may be deformable during metal processing. The contact surface 116 may be provided on the roll 104 using various techniques or processes as desired. The particular roll 104 with the contact surface 116 illustrated in FIGS. 1-6 should not be considered limiting.

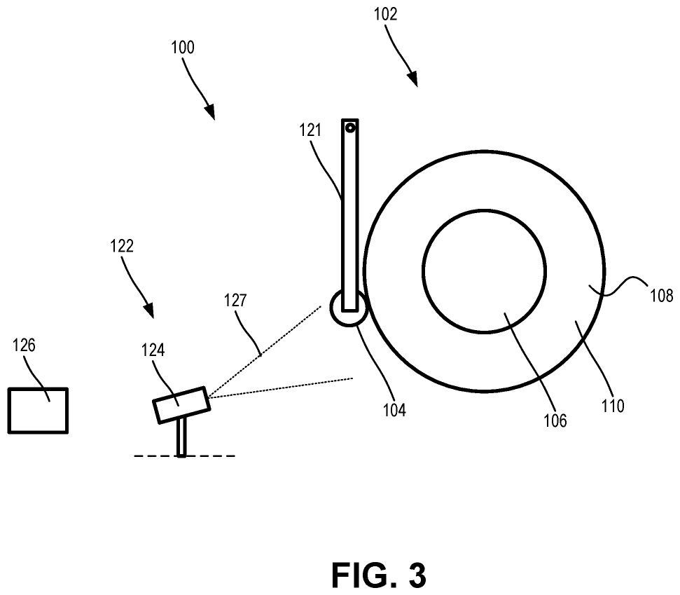

Referring to FIGS. 1 and 3, during metal processing, the roll 104 may be supported on a support 121 such that at least the contact surface 116 contacts the coil 108. The particular support 121 illustrated should not be considered limiting, and various devices or structures as desired may be utilized as the support 121. In some embodiments, at least one of the ends 112, 114 of the roll 104 is driven via various suitable actuators or drive mechanisms such that the roll 104 maintains contact with the coil 108 as it rotates about its axis 118 (see FIG. 2).

As illustrated by comparing FIG. 1 with FIG. 3, the roll 104 is movable in a radial direction as the coil 108 changes size from a smaller (or initial) size (FIG. 1) and an end (or larger) size (FIG. 3). The contact between the contact surface 116 and the coil 108 may subject the contact surface 116 to thermal oscillation and variation, which in turn may eventually cause failure of the contact surface 116 and potential damage to the metal substrate 110. In addition, during metal processing, the actuators of the roll 104 may cause flatness issues in the metal substrate 110 due to wobbling movement, and such flatness issues may make the metal substrate 110 unsuitable for its intended purpose and/or require correction before further processing. As illustrated in FIGS. 1 and 3, for example, to minimize and/or prevent problems from the roll 104, the metal processing system 100 includes a control system 122 that measures a temperature of at least the contact surface 116 and generates an output response based on the measured temperature.

In certain embodiments, the control system 122 includes a sensor 124 and a controller 126. While a single sensor 124 and a single controller 126 are illustrated, in other embodiments the control system 122 may have any number of sensors 124 and/or controllers 126 as desired.

The sensor 124 of the control system 122 may be various suitable devices or mechanisms for detecting a temperature of at least the contact surface 116 of the roll 104. In certain embodiments, the sensor 124 is a thermal camera with a field of view 127. In various embodiments, the thermal camera may be a high frame rate thermal camera that obtains images at a rate greater than an operating frequency of the roll 104 to avoid or minimize an aliasing effect. As some non-limiting examples, the sensor 124 may obtain images at a frame rate of greater than 20 Hz, such as greater than 30 Hz, such as greater than 40 Hz, such as greater than 50 Hz, such as greater than 60 Hz. In some non-limiting examples, the thermal camera as the sensor 120 may have an acquisition rate of greater than 60 Hz, such as about 70 Hz. In other embodiments, cameras with other acquisition rates may be utilized as desired.

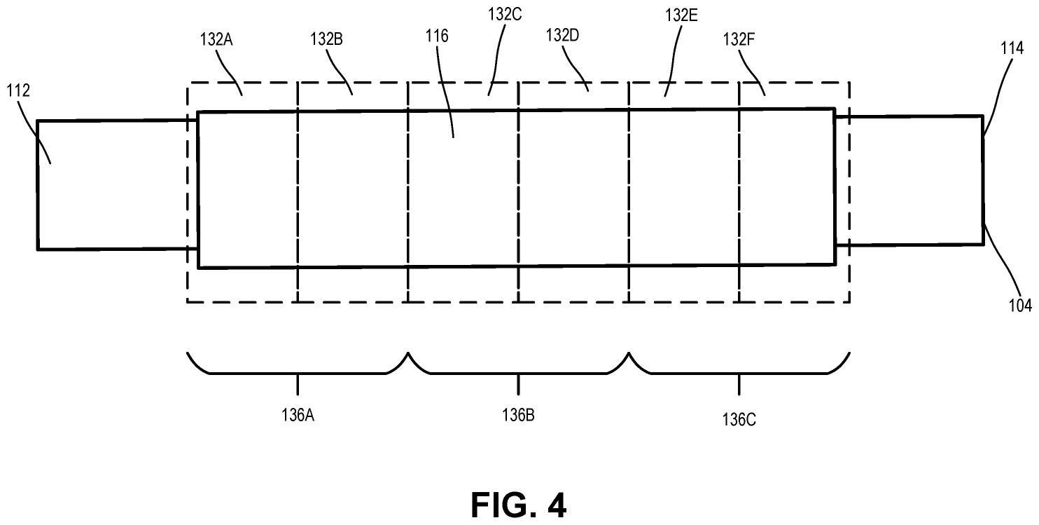

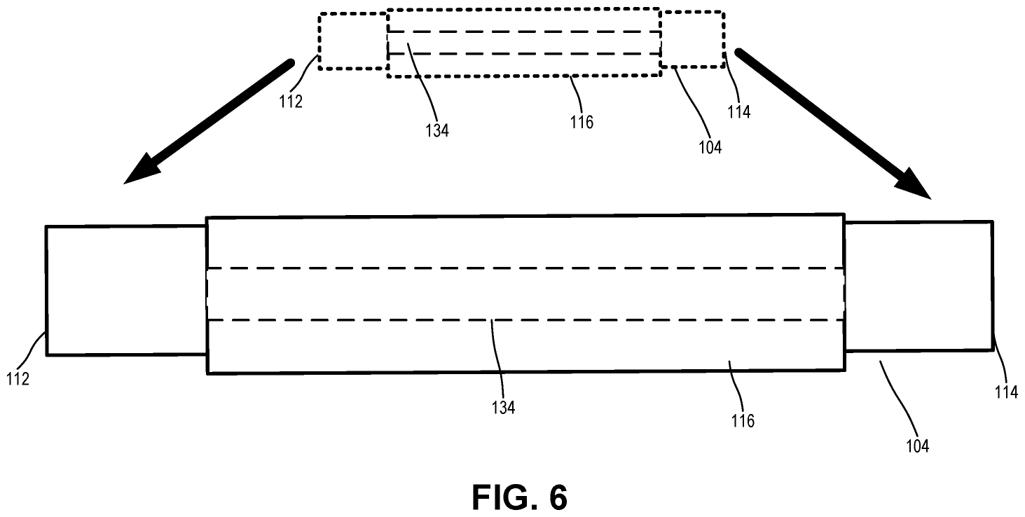

In various embodiments, and as illustrated in FIG. 4, the sensor 124 may detect a temperature of at least the contact surface 116 of the roll 104 using one or more detection zones 132 on the roll 104 between the ends 112, 114. In the embodiment illustrated in FIG. 4, the sensor 124 detects a temperature in six detection zones 132A-F; however, the number of detection zones 132 should not be considered limiting. In some non-limiting examples, the sensor 124 may use at least two detection zones, at least three detection zones, at least four detection zones, or at least five detection zones. In one non-limiting example, the sensor 124 may include at least ten detection zones, such as at least fifteen detection zones, such as at least twenty detection zones. In various embodiments, the sensor 124 independently detects the temperature in each detection zone. As an example, the sensor 124 detects the temperature of the contact surface 116 within detection zone 132A independently from the detection of the temperature of the contact surface 116 within detection zone 132B. In certain embodiments, and as discussed in detail below, the plurality of detection zones 132 may improve temperature measurement and control of the roll 104 using the control system 122. The particular size or area of each detection zone 132 relative to the roll 104 illustrated in FIG. 4 should not be considered limiting, and in other embodiments the detection zones 132 need not cover a complete width of the roll 104. FIG. 6 illustrates a non-limiting example where a detection area 134 (i.e., all of the detection zones 132) is less than the width of the roll 104.

In various embodiments, a plurality of detection zones 132 may together form a detection region 136. The number of detection zones 132 within a particular detection region 136 need not be the same along the roll 104. In the embodiment illustrated in FIG. 4, the roll 104 includes three detection regions 136-a first detection region 136A formed by detection zones 132A-B; a second detection region 136B formed by detection zones 132C-D; and a third detection region 136C formed by detection zones 132E-F. The number of detection regions 136 should not be considered limiting. When included, the number of detection regions 136 may be less than or equal to the number of detection zones 132.

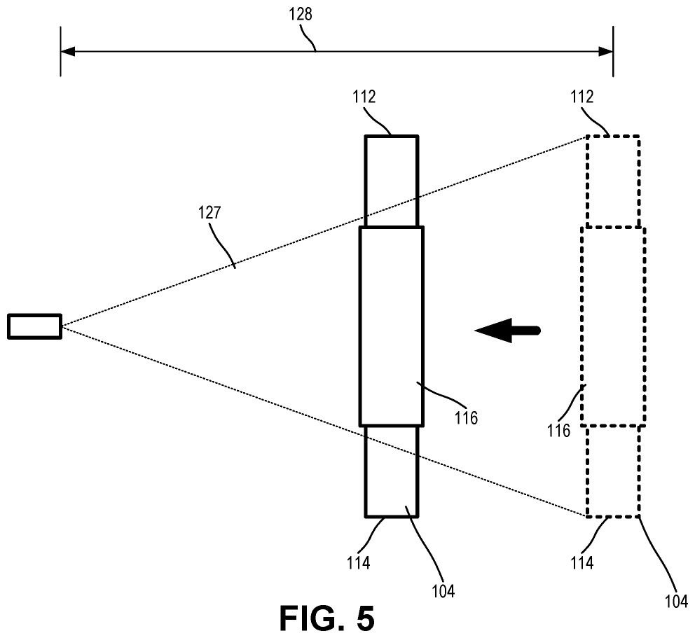

In certain embodiments, and as illustrated in FIG. 5, the sensor 124 is provided at a predetermined distance 128 from an initial position of the roll 104 (e.g., the position of the roll 104 in FIG. 1, and represented by the roll 104 in dashed lines in FIG. 5). At such a predetermined distance, at least the contact surface 116 may be within the field of view 127 in both the initial position and an end position (represented by the roll 104 in solid lines in FIG. 5).

Referring to FIG. 6, a detection area 134, which is the combined detection zones 132, may be controlled to maintain its size or area relative to the roll 104. In FIG. 6, the individual detection zones 132 are omitted for clarity of the figure. In these embodiments, the sensor 124 may automatically adjust its focus such that the detection area 134 is adjusted based on the position of the roll 104 relative to the sensor 124. Such automatic adjustment of the focus and detection area 134 may provide improved temperature measurements and control of the roll 104 using the control system 122. As a non-limiting example, in FIG. 6, the detection area 134 on the roll 104 in the initial position (represented by dashed lines) is smaller than the detection area 134 of the roll in the end position (represented by solid lines, and closer to the sensor 124), but the size of the detection area 134 relative to the roll 104 is the same in both the initial position and the end position.

Referring back to FIG. 1, the sensor 124 optionally may be provided at an angle 130 relative to the roll 104. In such embodiments, the sensor 124 may be provided below the roll 104 and the angle 130 optionally may be an oblique angle as illustrated in FIG. 1. In such embodiments, the angle 130 may further facilitate having at least the contact surface 116 within the field of view 127 as the roll 104 is moved in a radial direction. In other embodiments, the angle 130 of the sensor 124 may be any other angle as desired, and the sensor 124 need not be positioned below the roll 104 and/or at an oblique angle 130.

The controller 126 of the control system 122 may include one or more processing units and/or one or more memory devices. The processing unit of the controller may be various suitable processing devices or combinations of devices including but not limited to one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units, and/or a combination thereof. The one or more memory devices of the controller 126 may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium”, “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In certain embodiments, the controller 126 optionally includes an associated user interface, including but not limited to a graphical user interface, such that the controller 126 may obtain information from a user and/or provide information to the user. In such embodiments, the user interface may be on the controller 126 itself or may be at a location remote from the controller 126 such as, but not limited to, another location within the metal processing system 100. Additionally, or alternatively, the controller 126 optionally may include various communication modules such that the controller 126 may receive and/or send information as desired. Non-limiting examples of communication modules may include systems and mechanisms enabling wired communication and/or wireless communication (e.g., Industrial Ethernet, Profibus®, near field, cellular, Wi-Fi, Bluetooth®, Bluetooth Low Energy (BLE), etc.).

The controller 126 of the control system 122 is communicatively coupled to the sensor 124 such that the controller 126 receives the thermal data from the sensor 124 for the one or more detection zones 132 and/or the one or more detection regions 136. In various embodiments, the controller 126 and/or the sensor 124 may determine the temperature for a particular detection zone 132 and/or detection region 136 using various techniques as desired, including based on a maximum temperature detected within the particular detection zone 132 and/or detection region 136, an average of the temperatures detected within the particular detection zone 132 and/or detection region 136, the temperature at a center of the detection zone 132 and/or detection region 136, and/or as otherwise desired.

The controller 126 may generate various output responses based on the temperature data from the sensor 124. Output responses may include, but are not limited to, generating an alert or notification (e.g., audio or visual) on a user interface of the controller 126, sending an alert or notification to an operator, controlling an operating parameter of the roll 104 (e.g., by sending a control signal to an actuator or control device of the roll 104), and/or controlling an operating parameter of the metal processing system 100 (e.g., by sending a control signal to an actuator or control device of the metal processing system 100). The operating parameter of the roll 104 may include, but is not limited to, a roll force, a tilt of the roll 104, pressure application from an actuator on the roll 104, combinations thereof, and/or various other operating parameters as desired, and control of such operating parameters may include controlling a driving mechanism of the roll 104, actuators of the roll 104 causing the roll 104 to apply the roll force, combinations thereof, and/or as otherwise desired. The operating parameter of the metal processing system may include, but is not limited to, a line speed, a coiling rate, an uncoiling rate, combinations thereof, and/or various other operating parameters as desired, and control of such operating parameters may include controlling a work stand upstream from the coiler 106, a driving mechanism controlling a rate of rotation of the coiler 106, combinations thereof, and/or as otherwise desired.

The output response from the controller 126 may be based on various analysis of the measured temperature from the sensor 124 as desired.

As one non-limiting example, the output response from the controller 126 may be based on a comparison of a measured temperature for a particular detection zone 132 and/or detection region 136 to a threshold temperature for the particular detection zone 132 and/or detection region 136. In such embodiments, the threshold temperature may correspond with a temperature at which the contact surface 116 fails and may be predetermined, calculated, or otherwise generated or provided as desired. In other embodiments, the threshold temperature may be other temperatures as desired and need not be a failure temperature of the contact surface 116. In embodiments with this comparison, the controller 126 may generate the output response based on one of the detection zones 132 having a measured temperature being within a predetermined range and/or exceeding the threshold temperature. As a non-limiting example, the controller 126 may generate the output response of controlling an actuator of the roll 104 to reduce the roll force for the portion of the roll 104 in detection region 136A and reduce a temperature of the roll 104 in detection region 136A based on the detection region 136A having a measured temperature exceeding its threshold temperature. Additionally, or alternatively, the output response may include an alert or alarm that is provided to the operator based on the measured temperature exceeding or being within the range of the threshold temperature.

As another non-limiting example, the output response from the controller 126 may be based on a comparison of the measured temperatures of adjacent detection zones 132 and/or detection regions 136. In such embodiments, the output response may be generated if a change in temperature between adjacent detection zones 132 and/or detection regions 136 is within a predetermined range or exceeds a threshold value. As a non-limiting example, the controller may generate the output response based on a difference between the measured temperature of detection region 132C and detection region 132D exceeding a threshold value. Additionally, or alternatively, the output response may include an alert or alarm that is provided to the operator based on the difference in temperatures exceeding or being within the range of the threshold value.

As yet another non-limiting example, the output response from the controller 126 may be based on the measured temperature of each of the detection regions 136. In such embodiments, the measured temperatures from each detection zone 132 may be used to derive temperature values for each of the detection regions 136. Optionally, a difference between detection region 136A and the detection region 136C may be used to adjust a difference in roll force applied on the first end 112 and the second end 114, e.g. if the temperature is higher in the detection region 136A, the force can be adjusted to reduce force on first end 112 and to increase it on the second end 114. As another non-limiting example, a difference between the detection region 136B (e.g., in a center of the roll 104) and an average of the temperature of the detection regions 136A, 136C (or edge control temperature) may be used to increase or decrease the total ironing roll force, e.g., if the temperature gradient from the center to the edge control temperature exceeds a certain limit, the total ironing roll force may be increased.

As a further non-limiting example, the output response from the controller 126 may be based on a curvature or profile of a temperature signal along the roll 104, which may correspond to a pressure distribution from one or more actuators of the roll 104. In such embodiments, the temperature signal may be the combined measured temperatures along the roll 104, and the controller 126 may compare the temperature signal to a target signal and/or determine oscillations in the temperature signal above a threshold. As a non-limiting example, the controller 126 may control pressure applied by actuators (e.g., pneumatic cylinders) on the roll 104 to improve flatness in the metal substrate 110 based on an identification of a plurality of oscillations in the temperature signal and/or that the temperature signal has a “wavy” profile.

As another non-limiting example, the controller 126 may predict future performance of the roll 104 based on the detected temperatures, and the controller 126 may generate an alert based on the predicted performance meeting a predetermined condition. As a non-limiting example, the controller 126 may predict a remaining useful life of the roll 104 based on historical temperatures of the roll 104 and/or current measured temperatures of the roll 104, and the controller 126 may generate an alert or alarm to the operator based on the remaining useful life of the roll 104 being less than a predetermined minimum remaining life for the roll 104.

Various other analysis may be performed by the controller 126 as desired, and the aforementioned examples should not be considered limiting.

The output response from the controller 126 based on the measured temperature of the contact surface 116 may provide improved control of the roll 104, which may provide benefits including but not limited to minimizing or preventing failure of the contact surface 116 during metal processing and/or providing the metal substrate 110 with improved flatness.

Referring to FIG. 1, a method of controlling the roll 104 with the contact surface 116 may include receiving, by the controller 126, a detected temperature of at least a portion of the contact surface 116 of the roll 104 from the sensor 124. The method includes generating, by the controller 126, an output response based on the received temperature. In some embodiments, generating the output response includes one or more of controlling an operating parameter of the roll 104, controlling an operating parameter of the metal processing system, or generating an alert or alarm to an operator.

In some embodiments, controlling the roll includes adjusting an operating parameter of the roll based on the received temperature exceeding a threshold temperature. Optionally, controlling the roll may include controlling at least one actuator of the roll for controlling a roll force from the roll.

In various embodiments, receiving the detected temperature from the sensor 124 includes independently receiving a detected temperature for each detection zone 132 of the plurality of detection zones 132 along the roll 104. Optionally, controlling the roll 104 is based on at least one of the detected temperature for a particular detection zone 132 exceeding a threshold temperature for that particular detection zone 132 or a difference between the detected temperature of a first detection zone (e.g., detection zone 132A) of the plurality of detection zones 132 and the detected temperature of a second detection zone (e.g., detection zone 132B or 132F) of the plurality of detection zones 132 exceeding a threshold limit.

In some embodiments, the method includes determining a pressure distribution of at least one actuator on the roll based on a temperature signal formed by the detected temperatures. In some embodiments, generating the output response may include controlling the at least one actuator of the roll 104 based on the determined pressure distribution.

Optionally, the method may include predicting performance of the roll based on the detected temperature and generating an alert based on the predicted performance meeting a predetermined condition. Optionally, generating the alert includes generating a visual alert or an auditory alert to the operator.

Various other processes may be performed using the control system 122, and the aforementioned control process should not be considered limiting.

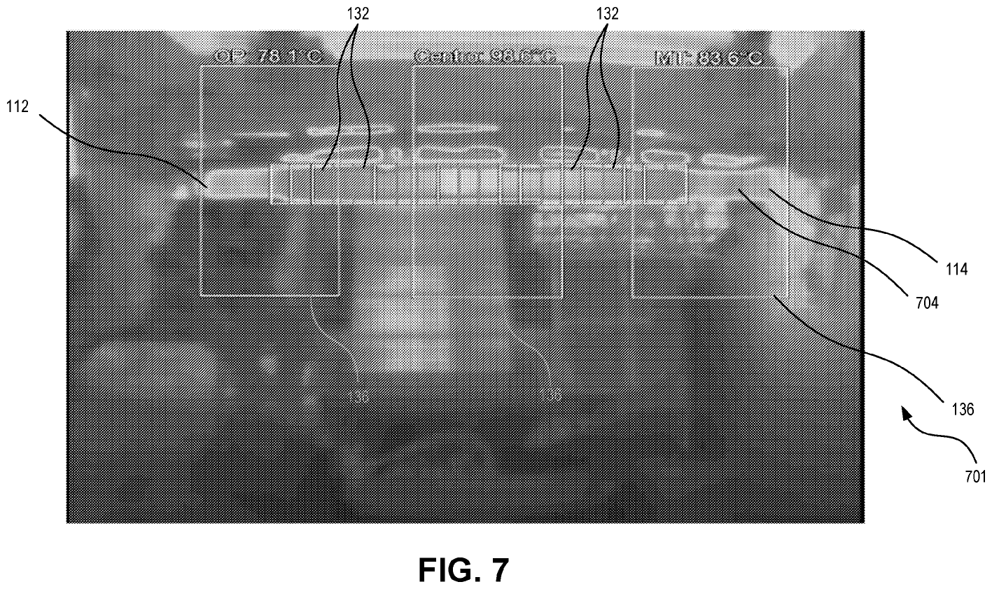

FIG. 7 illustrates an example of a thermal image 701 of a roll 704 from a control system similar to the control system 122. Compared to FIG. 4, the thermal image 701 includes twenty detection zones 132 and three detection regions 136.

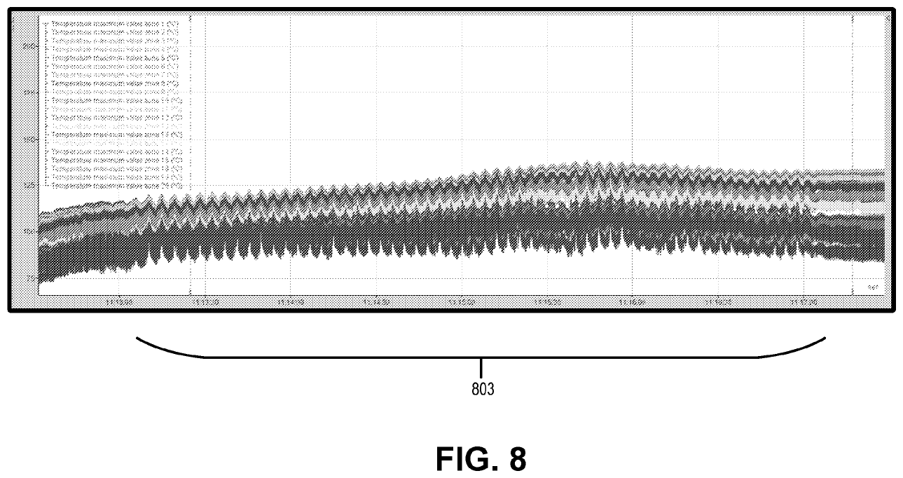

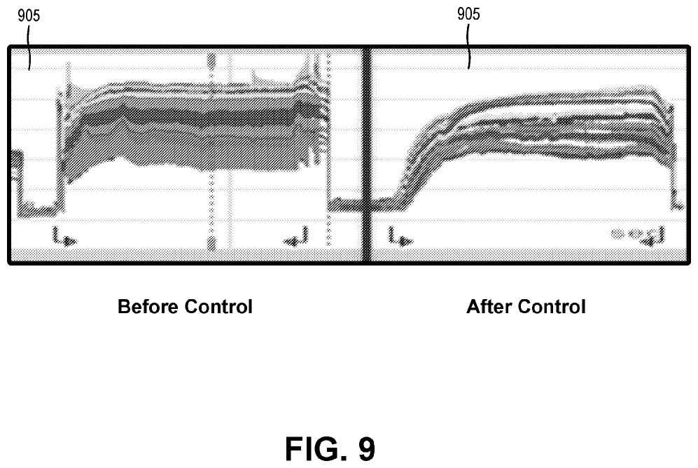

FIG. 8 illustrates a plurality of temperature signals of a plurality of rolls similar to the roll 104 obtained using a control system similar to the control system 122. As illustrated in FIG. 9, each temperature signal has a “wavy” portion (see, e.g., region 803 of the temperature signals), which is caused by wobbling movement of the rolls due to actuators of the roll. The controller 126 may adjust the actuators of the rolls and/or generate various other outputs to minimize such oscillations.

FIG. 9 illustrates a plurality of temperature signals of rolls similar to the roll 104 as measured and temperature signals of the same rolls after the control system 122 controls the rolls based on the measured temperature. As illustrated, before control by the control system 122, portions of certain rolls had temperatures exceeding a threshold temperature 905. In these embodiments, responsive to such detected temperatures, the control system 122 controlled the rolls (e.g., by adjusting actuators, controlling the line speed of the metal substrate, etc.) such that the temperature of the rolls is below the threshold temperature 905.

A collection of exemplary embodiments is provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A metal processing system comprising: a roll configured to rotate about an axis, the roll comprising a first end, a second end, and a non-metal surface between the first end and the second end for contacting a metal substrate; and a control system comprising: a sensor configured to detect a temperature of the non-metal surface of the roll; and a controller communicatively coupled with the sensor, wherein the controller is configured to receive the detected temperature from the sensor and control the roll based on the detected temperature.

Illustration 2. The metal processing system of any preceding or subsequent illustrations or combination of illustrations, wherein the roll is an ironing roll for contacting a coil of the metal substrate, and non-metal surface comprises a deformable material.

Illustration 3. The metal processing system of any preceding or subsequent illustrations or combination of illustrations, wherein the deformable material comprises a rubber material.

Illustration 4. The metal processing system of any preceding or subsequent illustrations or combination of illustrations, wherein the sensor comprises a thermal camera, and wherein the thermal camera is configured to detect the temperature at a frame rate of at least 60 Hz.

Illustration 5. The metal processing system of any preceding or subsequent illustrations or combination of illustrations, wherein the frame rate is at least 70 Hz.

Illustration 6. The metal processing system of any preceding or subsequent illustrations or combination of illustrations, wherein the sensor is configured to detect the temperature of the non-metal surface of the roll by: generating a plurality of independent detection zones along the roll between the first end and the second end; and independently detect a temperature of the non-metal surface in each detection zone of the plurality of detection zones.

Illustration 7. The metal processing system of any preceding or subsequent illustrations or combination of illustrations, wherein the plurality of independent detection zones comprises at least three detection zones.

Illustration 8. The metal processing system of any preceding or subsequent illustrations or combination of illustrations, wherein the controller is configured to: receive the detected temperature of each detection zone of the plurality of detection zones; for each detection zone, compare the detected temperature to a threshold temperature for the particular detection zone; and control the roll based on the detected temperature for at least one detection zone of the plurality of detection zones exceeding the threshold temperature for that particular detection zone.

Illustration 9. The metal processing system of any preceding or subsequent illustrations or combination of illustrations, wherein the controller is configured to: receive the detected temperature of each detection zone of the plurality of detection zones; compare a detected temperature of a first detection zone of the plurality of detection zones with a detected temperature of a second detection zone of the plurality of detection zones; and control the roll based on a difference between the detected temperature of the first detection zone and the detected temperature of the second detection zone.

Illustration 10. The metal processing system of any preceding or subsequent illustrations or combination of illustrations, wherein the first detection zone of the plurality of detection zones is at the first end or the second end of the roll, and wherein the second detection zone of the plurality of detection zones is between the first end and the second end of the roll.

Illustration 11. The metal processing system of any preceding or subsequent illustrations or combination of illustrations, wherein the controller is configured to control the roll based on the difference between the detected temperature of the first detection zone and the detected temperature of the second detection zone exceeding a threshold limit.

Illustration 12. The metal processing system of any preceding or subsequent illustrations or combination of illustrations 6, wherein the sensor is configured to change a size of each detection zone based on a change in distance between the roll and the sensor.

Illustration 13. The metal processing system of any preceding or subsequent illustrations or combination of illustrations, wherein the sensor is configured to detect a maximum temperature for each detection zone or an average temperature for each detection zone.

Illustration 14. The metal processing system of any preceding or subsequent illustrations or combination of illustrations, wherein the controller is configured to control the roll by controlling a roll force applied by the roll, and wherein controlling the roll force comprises controlling at least one actuator for the roll.

Illustration 15. The metal processing system of any preceding or subsequent illustrations or combination of illustrations, wherein the controller is further configured to generate an alert based on the detected temperature exceeding a threshold temperature.

Illustration 16. The metal processing system of any preceding or subsequent illustrations or combination of illustrations, wherein the controller is further configured to determine a pressure distribution of at least one actuator on the roll based on the detected temperature and control the at least one actuator based on the determined pressure distribution.

Illustration 17. The metal processing system of any preceding or subsequent illustrations or combination of illustrations wherein the controller is further configured to predict performance of the roll based on the detected temperature and generate an alert based on the predicted performance meeting a predetermined condition.

Illustration 18. The metal processing system of any preceding or subsequent illustrations or combination of illustrations, wherein the predetermined condition comprises a failure of the non-metal surface of the roll.

Illustration 19. A control system for a metal processing system comprising a roll, the roll comprising a non-metal contact surface, the control system comprising: a sensor for detecting a temperature of the non-metal contact surface of the roll; and a controller communicatively coupled with the sensor, the controller configured to receive the detected temperature from the sensor and generate an output signal for controlling the roll based on the received temperature.

Illustration 20. The control system of any preceding or subsequent illustrations or combination of illustrations, wherein the sensor comprises a thermal camera, and wherein the thermal camera is configured to detect the temperature at a frame rate of at least 60 Hz.

Illustration 21. The control system of any preceding or subsequent illustrations or combination of illustrations, wherein the frame rate is at least 70 Hz.

Illustration 22. The control system of any preceding or subsequent illustrations or combination of illustrations, wherein the sensor is configured to detect the temperature of the non-metal surface of the roll by generating a plurality of independent detection zones along the roll; and independently detect a temperature of the non-metal surface in each detection zone of the plurality of detection zones.

Illustration 23. The control system of any preceding or subsequent illustrations or combination of illustrations, wherein the plurality of independent detection zones comprises at least three detection zones.

Illustration 24. The control system of any preceding or subsequent illustrations or combination of illustrations, wherein the controller is configured to: receive the detected temperature of each detection zone of the plurality of detection zones; for each detection zone, compare the detected temperature to a threshold temperature for the particular detection zone; and generate the output signal based on the detected temperature for at least one detection zone of the plurality of detection zones exceeding the threshold temperature for that particular detection zone.

Illustration 25. The control system of any preceding or subsequent illustrations or combination of illustrations, wherein the controller is configured to: receive the detected temperature of each detection zone of the plurality of detection zones; compare a detected temperature of a first detection zone of the plurality of detection zones with a detected temperature of a second detection zone of the plurality of detection zones; and generate the output signal based on a difference between the detected temperature of the first detection zone and the detected temperature of the second detection zone.

Illustration 26. The control system of any preceding or subsequent illustrations or combination of illustrations, wherein the controller is configured to generate the output signal based on the difference between the detected temperature of the first detection zone and the detected temperature of the second detection zone exceeding a threshold limit.

Illustration 27. The control system of any preceding or subsequent illustrations or combination of illustrations, wherein the sensor is configured to detect a maximum temperature for each detection zone or an average temperature for each detection zone.

Illustration 28. The control system of any preceding or subsequent illustrations or combination of illustrations, wherein the controller is further configured to generate an alert based on the detected temperature exceeding a threshold temperature.

Illustration 29. The control system of any preceding or subsequent illustrations or combination of illustrations, wherein the controller is further configured to determine a pressure distribution of at least one actuator on the roll based on the detected temperature and control the at least one actuator based on the determined pressure distribution.

Illustration 30. The control system of any preceding or subsequent illustrations or combination of illustrations wherein the controller is further configured to predict performance of the roll based on the detected temperature and generate an alert based on the predicted performance meeting a predetermined condition.

Illustration 31. A method of controlling a roll comprising a non-metal contact surface for contacting a metal substrate, the method comprising: receiving a detected temperature of at least a portion of the non-metal contact surface of the roll from a sensor; and controlling the roll based on the received temperature for at least the portion of the non-metal contact surface.

Illustration 32. The method of any preceding or subsequent illustrations or combination of illustrations, wherein controlling the roll comprises adjusting an operating parameter of the roll based on the received temperature exceeding a threshold temperature.

Illustration 33. The method of any preceding or subsequent illustrations or combination of illustrations, wherein receiving the detected temperature comprises independently receiving a detected temperature for each detection zone of a plurality of detection zones along the roll, and wherein controlling the roll is based on at least one of: the detected temperature for a particular detection zone exceeds a threshold temperature for that particular detection zone; or a difference between the detected temperature of a first detection zone of the plurality of detection zones and the detected temperature of a second detection zone of the plurality of detection zones exceeds a threshold limit.

Illustration 34. The method of any preceding or subsequent illustrations or combination of illustrations, wherein controlling the roll comprises controlling at least one actuator of the roll for controlling a roll force from the roll.

Illustration 35. The method of any preceding or subsequent illustrations or combination of illustrations, further comprising determining a pressure distribution of at least one actuator on the roll based on the detected temperature and controlling the at least one actuator based on the determined pressure distribution.

Illustration 36. The method of any preceding or subsequent illustrations or combination of illustrations, further comprising predicting performance of the roll based on the detected temperature and generating an alert based on the predicted performance meeting a predetermined condition.

Illustration 37. The method of any preceding or subsequent illustrations or combination of illustrations, wherein generating the alert comprises generating a visual alert or an auditory alert.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. In the figures and the description, like numerals are intended to represent like elements. As used herein, the meaning of “a,” “an,” and “the” includes singular and plural references unless the context clearly dictates otherwise.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A metal processing system comprising:
a roll configured to rotate about an axis, the roll comprising a first end, a second end, and a non-metal surface between the first end and the second end for contacting a metal substrate; and
a control system comprising:
a sensor configured to detect a temperature of the non-metal surface of the roll; and
a controller communicatively coupled with the sensor, wherein the controller is configured to receive the detected temperature from the sensor and control the roll based on the detected temperature.

2. The metal processing system of claim 1, wherein the roll is an ironing roll for contacting a coil of the metal substrate, and the non-metal surface comprises a deformable material.

3. The metal processing system of claim 1, wherein the sensor comprises a thermal camera, and wherein the thermal camera is configured to detect the temperature at a frame rate of at least 60 Hz.

4. The metal processing system of claim 1, wherein the sensor is configured to detect the temperature of the non-metal surface of the roll by:
generating a plurality of independent detection zones along the roll between the first end and the second end; and
independently detecting a temperature of the non-metal surface in each detection zone of the plurality of detection zones.

5. The metal processing system of claim 4, wherein the controller is configured to:
receive the detected temperature of each detection zone of the plurality of detection zones;
for each detection zone, compare the detected temperature to a threshold temperature for the particular detection zone; and
control the roll based on the detected temperature for at least one detection zone of the plurality of detection zones exceeding the threshold temperature for that particular detection zone.

6. The metal processing system of claim 4, wherein the controller is configured to:
receive the detected temperature of each detection zone of the plurality of detection zones;
compare a detected temperature of a first detection zone of the plurality of detection zones with a detected temperature of a second detection zone of the plurality of detection zones; and
control the roll based on a difference between the detected temperature of the first detection zone and the detected temperature of the second detection zone.

7. The metal processing system of claim 4, wherein the sensor is configured to change a size of each detection zone based on a change in distance between the roll and the sensor.

8. A control system for a metal processing system comprising a roll, the roll comprising a non-metal contact surface, the control system comprising:
a sensor for detecting a temperature of the non-metal contact surface of the roll; and
a controller communicatively coupled with the sensor, the controller configured to receive the detected temperature from the sensor and generate an output signal for controlling the roll based on the received temperature.

9. The control system of claim 8, wherein the sensor comprises a thermal camera, and wherein the thermal camera is configured to detect the temperature at a frame rate of at least 60 Hz.

10. The control system of claim 9, wherein the sensor is configured to detect the temperature of the non-metal surface of the roll by:
generating a plurality of independent detection zones along the roll; and
independently detecting a temperature of the non-metal surface in each detection zone of the plurality of detection zones.

11. The control system of claim 10, wherein the controller is configured to:
receive the detected temperature of each detection zone of the plurality of detection zones;
for each detection zone, compare the detected temperature to a threshold temperature for the particular detection zone; and
generate the output signal based on the detected temperature for at least one detection zone of the plurality of detection zones exceeding the threshold temperature for that particular detection zone.

12. The control system of claim 10, wherein the controller is configured to:
receive the detected temperature of each detection zone of the plurality of detection zones;
compare a detected temperature of a first detection zone of the plurality of detection zones with a detected temperature of a second detection zone of the plurality of detection zones; and
generate the output signal based on a difference between the detected temperature of the first detection zone and the detected temperature of the second detection zone.

13. The control system of claim 12, wherein the controller is configured to generate the output signal based on the difference between the detected temperature of the first detection zone and the detected temperature of the second detection zone exceeding a threshold limit.

14. The control system of claim 9, wherein the controller is further configured to determine a pressure distribution of at least one actuator on the roll based on the detected temperature and control the at least one actuator based on the determined pressure distribution.

15. The control system of claim 9, wherein the controller is further configured to predict performance of the roll based on the detected temperature and generate an alert based on the predicted performance meeting a predetermined condition.

16. A method of controlling a roll comprising a non-metal contact surface for contacting a metal substrate, the method comprising:
receiving a detected temperature of at least a portion of the non-metal contact surface of the roll from a sensor; and
controlling the roll based on the received temperature.

17. The method of claim 16, wherein receiving the detected temperature comprises independently receiving a detected temperature for each detection zone of a plurality of detection zones along the roll, and wherein controlling the roll is based on at least one of:
the detected temperature for a particular detection zone exceeding a threshold temperature for that particular detection zone; or
a difference between the detected temperature of a first detection zone of the plurality of detection zones and the detected temperature of a second detection zone of the plurality of detection zones exceeding a threshold limit.

18. The method of claim 16, wherein controlling the roll comprises controlling at least one actuator of the roll for controlling a roll force from the roll.

19. The method of claim 16, further comprising determining a pressure distribution of at least one actuator on the roll based on the detected temperature and controlling the at least one actuator based on the determined pressure distribution.

20. The method of claim 16, further comprising predicting performance of the roll based on the detected temperature and generating an alert based on the predicted performance meeting a predetermined condition.
